(19) United States
(12) Patent Application Publication
(10) Pub. No.: US 2014/0097953 A1
(43) Pub. Date: Apr. 10, 2014

(54) Alert Indication Signaling Device and Method

(71) Applicants: Majid Jelveh, Baltimore, MD (US); Cyrus Etemad-Moghadam, Fallston, MD (US)

(72) Inventors: Majid Jelveh, Baltimore, MD (US); Cyrus Etemad-Moghadam, Fallston, MD (US)

(73) Assignee: Wire Wrangler, LLC, Baltimore, MD (US)

(21) Appl. No.: 13/777,833

(22) Filed: Feb. 26, 2013

Related U.S. Application Data
(60) Provisional application No. 61/709,344, filed on Oct. 4, 2012.

(51) Int. Cl. G08B 19/00

(52) U.S. Cl. CPC G08B 19/00
USPC 340/517

(57) ABSTRACT

An alert indication signaling (AIS) device is provided. The AIS device includes a first detector that detects a first event, a line detector that detects a second event that includes an incoming call on a communication device, and a microcontroller directly connected to the first detector and the line detector. The microcontroller transmits at least one signal based on at least one of the first event and the second event. A display unit receives the at least one signal from the microcontroller. The display unit displays a visual message that indicates an occurrence of at least one of the first event and the second event based on the at least one signal. A speaker produces an audio output that corresponds to the visual message and at least one of the first event and the second event. The audio output and the visual message are concurrent.

### CROSS-REFERENCE TO RELATED APPLICATIONS

This application claims priority to U.S. Provisional Application Ser. No. 61/709,344 filed on Oct. 4, 2012, the complete disclosure of which, in its entirety, is herein incorporated by reference.

### BACKGROUND

1. Technical Field

The embodiments herein generally relate to alarm indication devices, and more particularly, to an alert indication signaling device that provides an audio and visual message based on one or more events.

2. Description of the Related Art

Conventional smoke alarms are typically provided in residential/commercial premises to alert occupants of smoke that may indicate a safety threat such as a fire. Generally, these alarms contain a red and green light and they may occasionally “chirp” or ‘beep’ without providing any further information as to the reason behind the “chirp”. Typically, different alarms are necessary to detect different emergency conditions (e.g., smoke, carbon monoxide, etc.), and the action needed to be taken based on the emergency conditions may also differ. In cases where a single alarm device is used to detect both smoke and carbon monoxide, the “chirp” or alarm sound is often the same for either type of detection, and the alarm device does not necessarily provide further information or differentiation of what type of detection occurred (e.g., whether smoke or carbon monoxide is detected) or the action required to be taken.

An occupant's behavior may require being different depending on whether there is smoke or carbon monoxide detected. The goal may be to vacate the premises irrespective of whether smoke or carbon monoxide is present. However, this is not necessarily the case. For example, if there is a small, isolated fire causing the alarm to detect smoke, then perhaps the occupant may first attempt to put out the fire prior to vacating the premises, and may decide not to vacate the premises at all upon putting out the fire. However, if carbon monoxide is detected, then the occupant will most likely vacate the premises immediately without attempting to locate the cause of the gas leak.

Additionally, for hearing impaired individuals, an alarm device providing only an audible sound for the alarm is not practical or useful. Similarly, for visually impaired individuals, an alarm device providing only a non-differentiating “chirp” or alarm irrespective of the type of detection (e.g., smoke or carbon monoxide) does not provide enough information to determine how to initially react to the alarm. Moreover, for visually impaired individuals, an alarm device that provides only a visual message is not useful.

As the population continues to age, and particularly with more elderly individuals living on their own, there remains a need for an improved cohesive alert system that can provide all kinds of individuals, including physically challenged persons, with an effective way of responding to emergency situations.

### SUMMARY

In view of the foregoing, an embodiment herein provides an alert indication signaling (AIS) device that includes a first detector that detects a first event, a line detector that detects a second event that includes an incoming call on a communication device, and a microcontroller directly connected to the first detector and the line detector. The microcontroller transmits at least one signal based on at least one of the first event and the second event. The alert indication signaling (AIS) device further includes a display unit that receives the at least one signal from the microcontroller. The display unit displays a visual message that indicates an occurrence of at least one of the first event and the second event based on the at least one signal. A speaker operatively connected to the display unit. The speaker produces an audio output that corresponds to the visual message and at least one of the first event and the second event. The audio output and the visual message are concurrent.

The first event may include any of carbon monoxide detection, smoke detection, and an emergency condition. The alert indication signaling device may further include a doorbell detector directly connected to the microcontroller, and a doorbell switch directly connected to the doorbell detector and the microcontroller. The doorbell detector detects a doorbell or an entry alarm when the doorbell switch is turned ON or OFF. The alert indication signaling device may further include a door switch directly connected to the microcontroller. The microcontroller detects an opening or closing of a door based on a signal received from the door switch. The alert indication signaling device may further include one or more pushbuttons that enable navigations and customization of user-configurable features of the alert indication device. Each of the pushbuttons may include one or more settings having an alarm audio level, a display backlight, a date and time, Wi-Fi settings, Bluetooth™ technology settings, alarm forwarding addresses, and an alarm location identifier assignment. One or more audio messages remain off until existing audio messages are terminated, when an alarm silence is activated.

In another aspect, a portable alert indication signaling device is provided. The portable alert indication signaling device includes a first detector that detects a first event, a line detector that detects a second event comprising an incoming call on a communication device, a doorbell detector that detects a third event comprising a door bell or an entry alarm when the doorbell switch is turned ON or OFF, and a microcontroller directly connected to the first detector, the line detector, and a doorbell detector. The microcontroller transmits at least one signal based on at least one of the first event, the second event, and the third event. The portable alert indication signaling device further includes a display unit directly connected to the microcontroller. The display unit displays a visual message that indicates an occurrence of at least one of the first event, the second event, and the third event based on the at least one signal. The portable alert indication signaling device further includes a speaker operatively connected to the display unit. The speaker produces an audio output that corresponds to the visual message and at least one of the first event, the second event, and the third event. The audio output and the visual message are concurrent.

The portable alert indication signaling device may further include a doorbell switch directly connected to the doorbell detector and the microcontroller, and a door switch directly connected to the microcontroller. The portable alert indication signaling device may further include one or more pushbuttons that enable navigation and customization of user-configurable features. Each of the pushbuttons may include one or more settings that include an alarm audio level, a display backlight, a date and time, Wi-Fi settings, Bluetooth™ technology settings, alarm forwarding addresses, and an alarm location identifier assignment.

In yet another aspect, a method of providing an alert is provided. The method includes detecting an event that indicates a safety threat, detecting an incoming call on a communication device, transmitting a signal from a microcontroller to a display unit and a speaker based on the safety threat or the incoming call, displaying a visual message that indicates an occurrence of at least one of the safety threat or the incoming call, and concurrently playing an audio message that corresponds to the visual message and the at least one of the safety threat or the incoming call.

The safety threat may include any of carbon monoxide detection, smoke detection, and an emergency condition. An opening or closing of a door may be detected by the microcontroller based on a signal received from the door switch.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a schematic diagram of an alarm indication signaling (AIS) device according to an embodiment herein;

FIG. 2 illustrates a visual message displayed that indicates an occurrence of a break in event on the display unit of the AIS device of FIG. 1 according to an embodiment herein;

FIG. 3 illustrates a visual message that indicates an occurrence of carbon monoxide detection displayed on the display unit of the AIS device of FIG. 1 according to an embodiment herein;

FIG. 4 illustrates a visual message that indicates an occurrence of an event from a front door displayed on the display unit of the AIS device of FIG. 1 according to an embodiment herein;

FIG. 5 illustrates a visual message that indicates an incoming call on a communication device displayed on the display unit of the AIS device of FIG. 1 according to an embodiment herein;

FIG. 6 illustrates a visual message that indicates a smoke detection displayed on the display unit of the AIS device of FIG. 1 according to an embodiment herein;

FIG. 7 illustrates a visual message that indicates a status of power supply displayed on the display unit of the AIS device of FIG. 1 according to an embodiment herein;

FIG. 8 illustrates a visual message displayed on the display unit of the AIS device of FIG. 1 according to an embodiment herein;

FIG. 9 illustrates a side view of the AIS device of FIG. 1 according to an embodiment herein;

FIG. 10 illustrates a front perspective view of the AIS device of FIG. 1 according to an embodiment herein;

FIG. 11 illustrates a bottom perspective view of the AIS device of FIG. 1 according to an embodiment herein;

FIG. 12 is a computer system used in accordance with the embodiments herein;

FIG. 13 illustrates a schematic diagram of the microcontroller of FIG. 1 according to an embodiment herein; and

FIG. 14 is a flow diagram illustrating a method of providing an alert according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

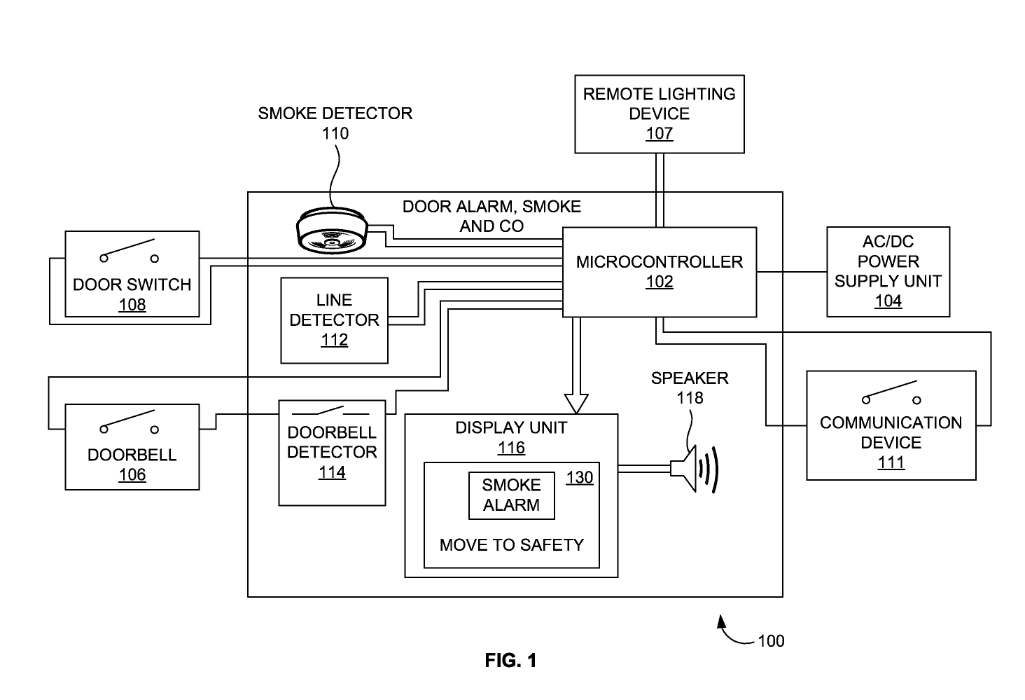

As mentioned, there remains a need for an improved cohesive alert system that can provide all kinds of individuals, including physically challenged persons, with an effective way of responding to emergency situations. The embodiments herein achieve this by providing an alert indication signaling device that alerts one or more individuals by providing audio and visual messages. The alert indication signaling device includes (i) one or more detectors that detect one or more emergency conditions/events, (ii) a microcontroller that transmits one or more signals to a display unit and a speaker based on the one or more emergency conditions/events. The display unit displays a visual message that indicates an occurrence of one or more events, and the speaker produces an audio output that corresponds to the visual message based on the one or more events. Referring now to the drawings, and more particularly to FIGS. 1 through 14, where similar reference characters denote corresponding features consistently throughout the figures, there are shown preferred embodiments.

FIG. 1 illustrates a schematic diagram of an alarm indication signaling (AIS) system 100 according to an embodiment herein. The AIS device 100 includes a microcontroller 102 that receives a power supply from an AC/DC or DC/DC power supply unit 104. A doorbell 106 and a door switch 108 may be communicatively linked to the AIS device 100. The AIS device 100 further includes a smoke detector 110, a line detector 112, a doorbell detector 114, a display unit 116, and a speaker 118. The power may be supplied from an external AC input or a low-voltage source to the AIS device 100. In one embodiment, the internal voltages present on the AIS device 100 will conform to a CE low-voltage standard. The smoke detector 110 is directly connected to the microcontroller 102. The smoke detector 110 detects a first event. The first event may include any of carbon monoxide detection, smoke detection, an operational setup guide, and an emergency, in one example embodiment. Additionally, the AIS device 100 may be connected to a remote lighting device 107 to control on/off and create a flashing sequence of lights to increase awareness of the occurrence of an emergency.

The line detector 112 is directly connected to the microcontroller 102. The line detector 112 detects a second event. The second event may be an incoming call from a communication device 111, in one example embodiment. The line detector 112 is configured to receive one or more signals from the communication device 111. A processor (not shown) within the microcontroller 102 transmits at least one signal based on the first event, the second event, or combinations thereof.

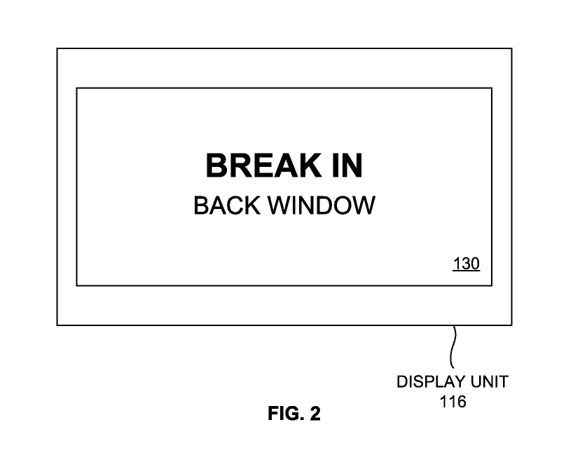

The display unit 116 is directly connected to the microcontroller 102. The display unit 116 displays a visual message that indicates an occurrence of at least one of the first event and the second event based on the at least one signal. The display unit 116 may include one or more liquid crystal display (LCD) panels (not shown), in one embodiment (although other embodiments may use different types of display panels), which displays an alarm and information pertinent to a user. In one embodiment, the LCD panel(s) may include one or more touchscreens 130. The LCD panels support multiple event and setup screens including a screen that detects a status of a door bell, an entry (door and/or window) alarm, carbon monoxide detection, smoke detection, telephone (land-line), and an operational setup guide (as further described with respect to FIGS. 2 through 8).

Fixed screens, streaming video, advertisements, or information and other interfaces may also be displayed on the display unit 116. In one embodiment, the one or more LCD panels generally are readable at a distance of at least 15 feet, and at a display angle of at least 60 degrees from vertical and at least 45 degrees from horizontal. The one or more LCD panels may include any type of suitable display (e.g., thin film transistor liquid crystal display (TFT-LCD), in one embodiment, although other types of displays may be used in accordance with the embodiments herein) having any suitable format or size or display resolution (e.g., HD, etc.), in one example embodiment. The display unit 116 may be single, or dual or multiple in number, and is preferably at least 5.0″ in size (diagonal display size). The backlighting of the LCD panels may be light-emitting diode (LED), in one example embodiment. Additionally, in one example embodiment, the LCD panel may be an x-y resistive feedback matrix based touchscreen, although other embodiments may include other types of touchscreens.

The AIS device 100 may include an input/output (I/O) component (not shown), which may further include a tactile switch (not shown) where the touchscreen functionality of the LCD panels may allow for modification of the functionality and configuration of the switches (e.g., the doorbell switch 106, and the door switch 108). A power jack (not shown), speaker 118, and alarm input mechanism (e.g., smoke detector 110) may also be included to provide for full I/O functionality of the AIS device 100. A wireless remote (not shown) can be used to remotely control the various components and mechanism of the AIS device 100.

The speaker 118 is directly connected to the display unit 116. The speaker 118 produces an audio output that corresponds to the visual message and at least one of the first event, the second event, or a third event. The audio output and the visual message are concurrent. The audio output may be played first, followed by the visual message, in one example embodiment. The visual message may be displayed first, followed by playing the audio output, in another example embodiment. The audio output and the visual message may be played and displayed at the same time. The AIS device 100 may include multiple speakers 118 to allow messages to be played for various emergency and communication conditions. The doorbell detector 114 is directly connected to the doorbell switch 106 and the microcontroller 102. The doorbell detector 114 is configured to detect the third event. The third event may be a door bell, an entry alarm, or a break in, in one example embodiment. Similarly, the door switch 108 is directly connected to the microcontroller 102. The microcontroller 102 may trigger the at least one signal based on the first event, the second event, the third event, or combinations thereof. The doorbell switch 106 and the door switch 108 may be configured as an alarm silence electro-mechanical switch, or any other reset switch. The AIS device 100 may include one or more batteries (not shown) that can be used for the battery backup.

Other occurrence of the one or more events may include an emergency power display based on an available power sensed from power sensor that is located in the power supply unit 104, and an operational guide set up which may be a fixed screen, streaming video or other information related to the AIS device 100.

FIG. 2, with reference to FIG. 1, illustrates a visual message that indicates an occurrence of a break in event displayed on the display unit 116 of the AIS device 100 of FIG. 1 according to an embodiment herein. The visual message indicates a break in back window, in one example embodiment. The visual message may be displayed in one or more color format. These colors format are illustrated as examples and may be changed depending on user requirements, local codes and customary requirements.

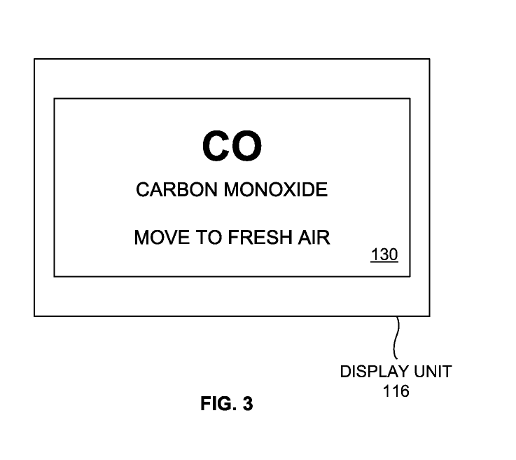

FIG. 3, with reference to FIG. 1, illustrates a visual message that indicates an occurrence of carbon monoxide detection displayed on the display unit 116 of the AIS device 100 of FIG. 1 according to an embodiment herein. In particular, FIG. 2 illustrates a visual message displayed on the display unit 116 based on the first event. The smoke detector 110 detects the carbon monoxide and triggers a signal to the microcontroller 102. The signal may be a trigger that indicates an event (e.g., the first event). The microcontroller 102 (or the processor) transmits a signal to the display unit 116. The display unit 116 may display a visual message indicates carbon monoxide, move to fresh air, in one example embodiment. The microcontroller 102 may further transmit the signal to the speaker 118 that indicates an audio message that corresponds to the visual message.

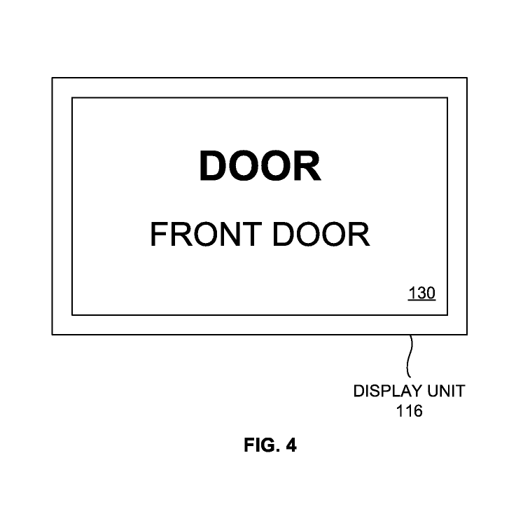

FIG. 4, with reference to FIG. 1, illustrates a visual message that indicates an occurrence of an event from a front door displayed on the display unit 116 of the AIS device 100 of FIG. 1 according to an embodiment herein. In particular, FIG. 4 illustrates the visual message that indicates an entry from a front door according to an embodiment herein. The door switch 108 detects an opening or a closing of a door (e.g., the front door). The microcontroller 102 transmits a signal to the display unit that corresponds to the opening or the closing of the front door. Moreover, other sensors can be connected as part of the security system.

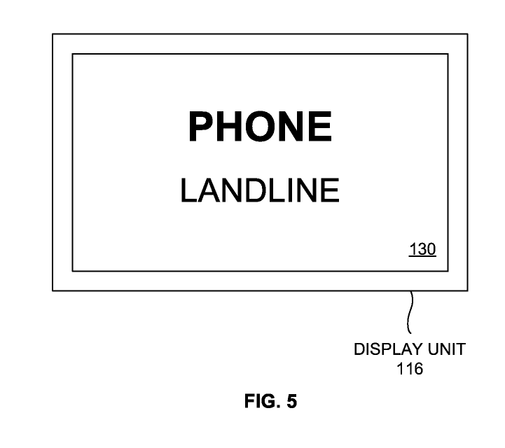

FIG. 5, with reference to FIG. 1, illustrates a visual message that indicates an incoming call on the communication device 111 displayed on the display unit 116 of the AIS device 100 of FIG. 1 according to an embodiment herein. The communication device 111 may be configured as a landline telephone, smartphone, tablet computer, in example embodiments. For example, Bluetooth™ technology may be integrated and used to connect to a wireless mobile phone or tablet computer. The microcontroller 102 may receive an input from the landline telephone. The microcontroller 102 transmits a signal based on the input. The display unit 116 may display a visual message that indicates an incoming call to or an outgoing call from the communication device 111.

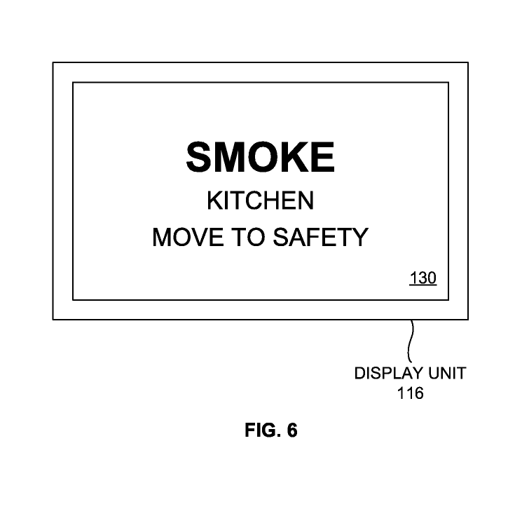

FIG. 6, with reference to FIG. 1, illustrates a visual message that indicates a smoke detection displayed on the display unit 116 of the AIS device 100 of FIG. 1 according to an embodiment herein. In particular, FIG. 6 illustrates the visual message that indicates a smoke detection according to an embodiment herein. The visual message indicates the smoke detection in a kitchen, move to safety, in one example embodiment.

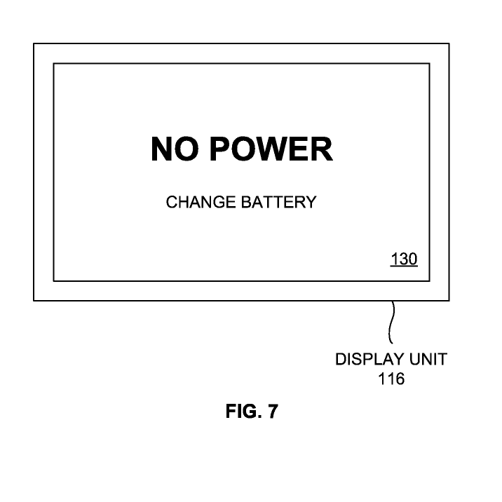

FIG. 7, with reference to FIG. 1, illustrates a visual message that indicates a status of power supply displayed on the display unit 116 of the AIS device 100 of FIG. 1 according to an embodiment herein. In particular, FIG. 7 illustrates the visual message that indicates “no power” according to an embodiment herein. The visual message indicates to replace/change a battery of the AIS device 100 of FIG. 1.

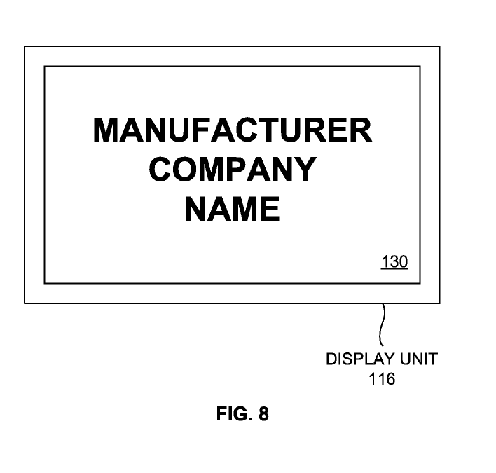

FIG. 8, with reference to FIG. 1, illustrates a visual message displayed on the display unit 116 of the AIS device 100 of FIG. 1 according to an embodiment herein. In particular, FIG. 8 illustrates the visual message that indicates an introduction that corresponds to a manufacturer or supplier of the AIS device 100 (e.g., “Manufacturer Company Name” according to an embodiment herein. Other types of messages may also be displayed on the display unit 116 including system information, advertisements, streaming news, weather, or other programmable information. Furthermore, while FIGS. 2 through 8 indicate that visual messages are displayed on the display unit 116, these messages may also be presented concurrent with an audio message describing the visual message that is being presented with the audio output occurring through the speaker 118 shown in FIG. 1.

The AIS device 100 may display the appropriate display screen in the event of an alarm actuation. Some display screens are considered alarm screens except for the “No Power” and the “Introduction” display, for example. The appropriate alarm screen(s) remain active until the alarm is no longer active. In the case where multiple alarms are active, the LCD panels display each active screen for a period of time and then activates the next active alarm screen. This periodic cycling of active alarm screens continues until an alarm is inactive.

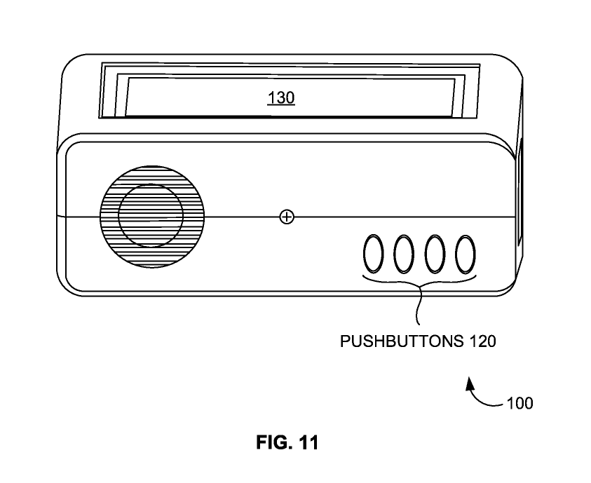

With respect to the audio announcement capabilities, the AIS device 100 has the capability to provide an audio alert (e.g., an audio message) for each individual type of alarm or information. The audio message may be in the form of a recorded .wav file, fixed frequency alarm tone, or custom alarm tone, in one example embodiment. The audio message may be silenced with an external pushbutton 120 (shown in FIG. 11). When the alarm silence is activated, the audio alarms will remain “off” until all existing alarms are terminated.

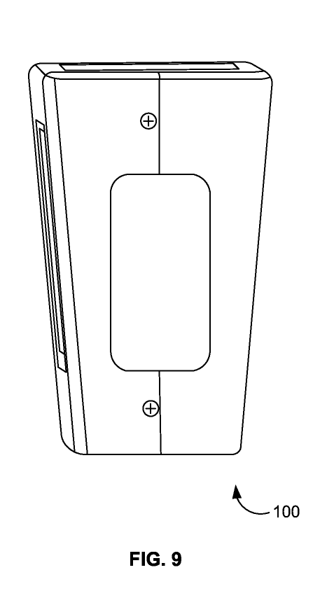

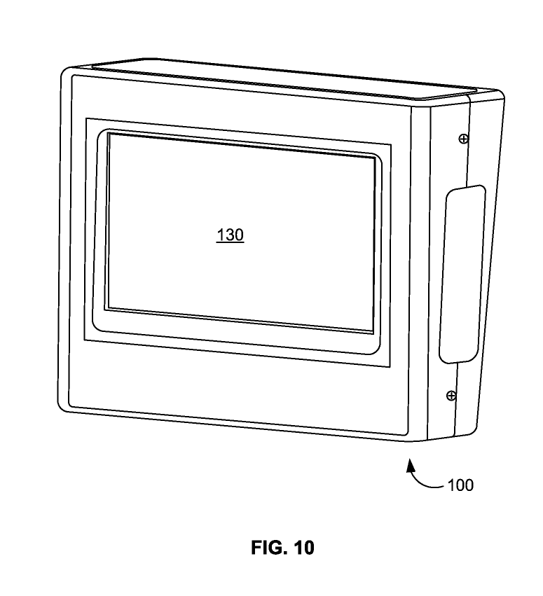

FIG. 9, with reference to FIGS. 1 through 8, illustrates a side view of the AIS device 100 of FIG. 1 according to an embodiment herein. FIG. 10, with reference to FIGS. 1 through 9, illustrates a front perspective view of the AIS device 100 of FIG. 1 according to an embodiment herein.

FIG. 11, with reference to FIGS. 1 through 10, illustrates a bottom perspective view of the AIS device 100 of FIG. 1 according to an embodiment herein. The bottom perspective view of the AIS device 100 includes one or more pushbuttons 120 (or equivalent touchscreen functions) to navigate and customize any user-configurable features. With respect to the configuration display screen, all user-configurable settings can be modified via the configuration display screen. The following unit features may be modified from the configuration screen: an alarm audio level, a display backlight, a date/time, Wi-Fi settings, Bluetooth™ technology settings, alarm forwarding addresses, an alarm location identifier assignment, and/or any other configuration necessary. All user-configurable settings can be retained in non-volatile memory or in firmware. Moreover, all user-configurable settings can be set to default to the last configured state upon re-application of power.

The embodiments herein can include both hardware and software elements. The embodiments that are implemented in software include but are not limited to, firmware, resident software, microcode, etc. For example, the microcontroller can be configured to run software either stored locally or stored and run from a remote site.

In this regard, the software elements can be stored in the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium, fixed or removable.

Input/output (I/O) devices (including but not limited to keyboards, displays, pointing devices, etc.) can be coupled to the system either directly or through intervening I/O controllers, wired or wireless. Network adapters may also be coupled to the system to enable the data processing system to become coupled to other data processing systems or remote printers or storage devices through intervening private or public networks.

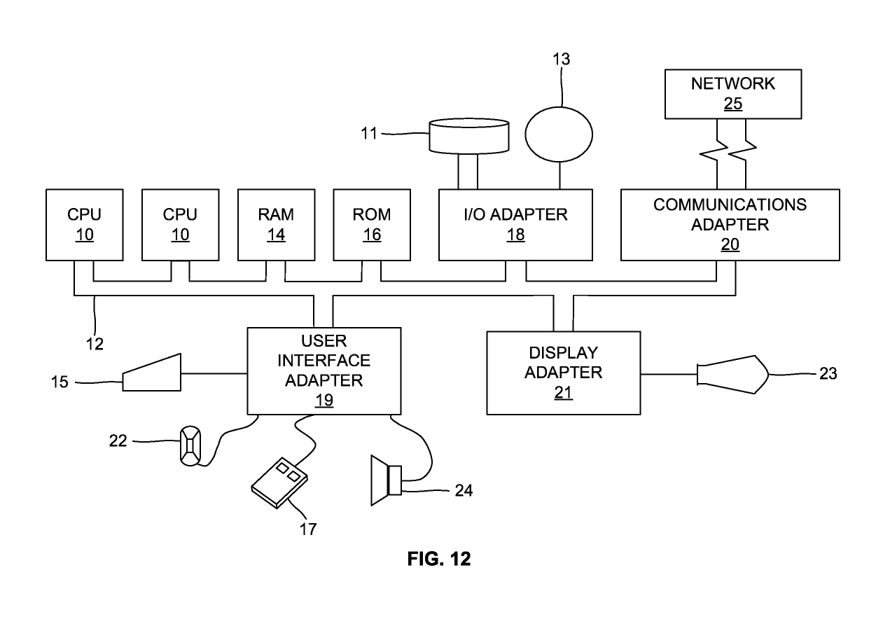

A representative hardware environment for practicing the software embodiments either locally or remotely is depicted in FIG. 12. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices 11, 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

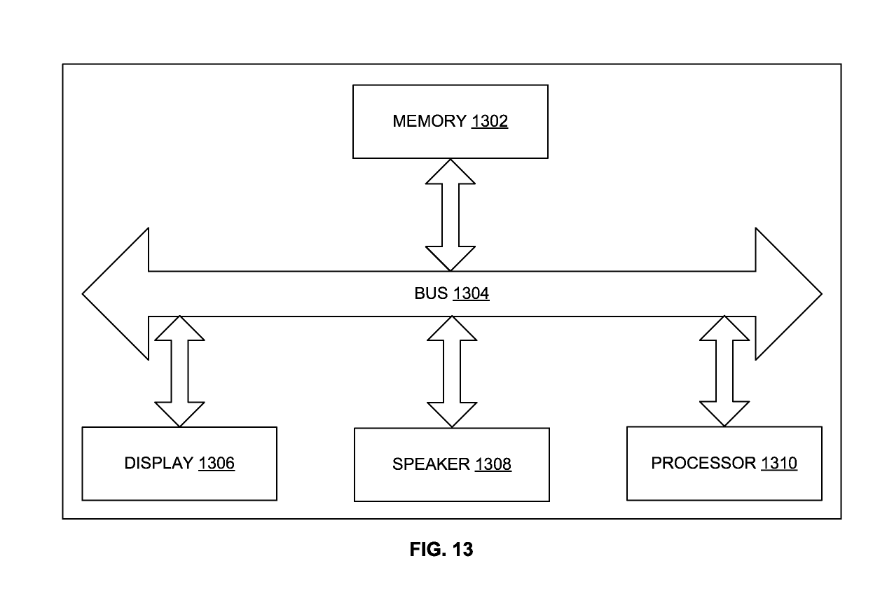

FIG. 13, with reference to FIGS. 1 through 12, illustrates a schematic diagram of the microcontroller 102 of FIG. 1 having a memory 1302 having a set of instructions, a bus 1304, a display 1306, a speaker 1308, and a processor 1310 capable of processing a set of instructions to perform any one or more of the methodologies herein, according to an embodiment herein. The processor 1310 may also enable digital content to be consumed in the form of video for output via one or more displays 1306 (e.g., the display unit 116 of FIG.

1) or audio for output via speaker and/or earphones 1308 (e.g., the speaker 118 of FIG. 1). The display unit 1306 and the speaker 1308 may be integrated as part of the microcontroller 102, in one embodiment. The display unit 1306 and the speaker 1308 may be connected as separate components to the microcontroller 102 (as shown in FIG. 1), in another embodiment. The processor 1310 may also carry out the methods described herein and in accordance with the embodiments herein.

Digital content may also be stored in the memory 1302 for future processing or consumption. The memory 1302 may also store program specific information and/or service information (PSI/SI), including information about digital content (e.g., the detected information bits) available in the future or stored from the past. The user of the microcontroller 102 may view this stored information on the display 1306 and select an item of for viewing, listening, or other uses via input, which may take the form of keypad, scroll, or other input device(s) or combinations thereof. When digital content is selected, the processor 1310 may pass information. The content and PSI/SI may be passed among functions within the microcontroller 102 using the bus 1304. The communication device 111 may include similar components such as the memory 1302 having a set of instructions, the bus 1304, the display 1306, the speaker 1308, and the processor 1310 capable of processing a set of instructions to perform any one or more of the methodologies herein, in one example embodiment.

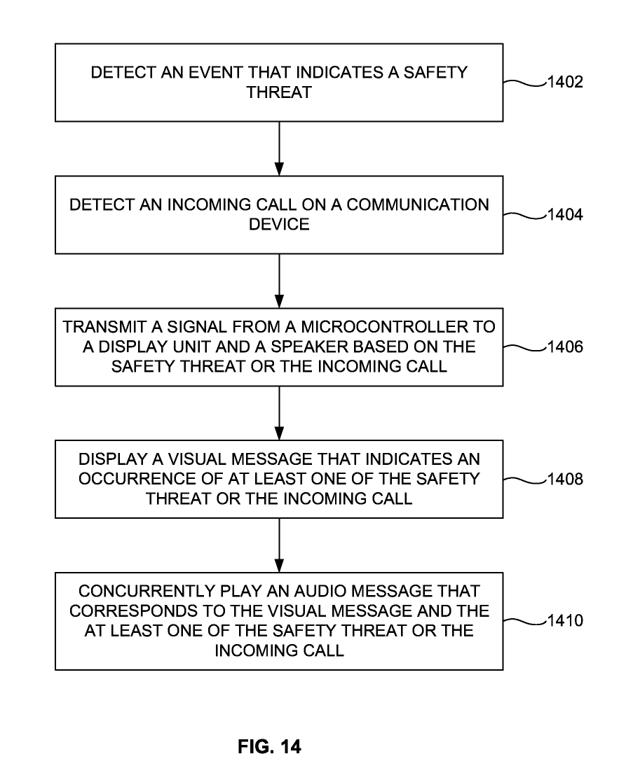

FIG. 14, with reference to FIGS. 1 through 13, is a flow diagram illustrating a method of providing an alert that is pertinent to a user using the alert indication signaling device 100 of FIG. 1 according to an embodiment herein. In step 1402, an event that indicates a safety threat is detected (e.g., using the smoke detector 110 of FIG. 1). The safety threat may be any of carbon monoxide detection, smoke detection, an operational setup guide, and an emergency, in one example embodiment. In step 1404, an incoming call on the communication device 111 is detected (e.g., using the line detector 112 of FIG. 1). In step 1406, a signal from the microcontroller 102 is transmitted to the display unit 116 and the speaker 118 based on the safety threat or the incoming call. In step 1408, a visual message that indicates an occurrence of at least one of the safety threat or the incoming call is displayed (e.g., on the display unit 116). In step 1410, an audio message that corresponds to the visual message and the at least one of the safety threat or the incoming call is concurrently played. An opening or closing of a door based on a signal received from the door switch 108 may be detected.

The AIS device 100 is configured to replace smoke alarms and carbon monoxide alarms that are in houses, buildings (e.g., commercial premises). The AIS device 100 may be configured to communicate with mobile communication devices 111 (e.g., smartphones, tablets, etc.) as well as computers and televisions as well as the fire department, police, hospital, etc., and may be linked to provide vibration to awake an occupant in the case of danger, or remove speakers for local alarm announcements. The AIS device 100 may be mounted on any surface, with I/O sourced using a “Decora-style” interface connector, terminal block or other wired interface.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. An alert indication signaling (AIS) device comprising:
a first detector that detects a first event;
a line detector that detects a second event comprising an incoming call on a communication device;
a microcontroller directly connected to said first detector and said line detector, wherein said microcontroller transmits at least one signal based on at least one of said first event and said second event;
a display unit that receives said at least one signal from said microcontroller, wherein said display unit displays a visual message that indicates an occurrence of at least one of said first event and said second event based on said at least one signal; and
a speaker operatively connected to said display unit, wherein said speaker produces an audio output that corresponds to said visual message and at least one of said first event and said second event, and wherein said audio output and said visual message are concurrent.

2. The alert indication signaling device of claim 1, wherein said first event comprises any of carbon monoxide detection, smoke detection, and an emergency condition.

3. The alert indication signaling device of claim 1, further comprising a doorbell detector directly connected to said microcontroller.

4. The alert indication signaling device of claim 3, further comprising a doorbell switch directly connected to said doorbell detector and said microcontroller, wherein said doorbell detector detects a doorbell or an entry alarm when said doorbell switch is turned ON or OFF.

5. The alert indication signaling device of claim 1, further comprising a door switch directly connected to said microcontroller, wherein said microcontroller detects an opening or closing of a door based on a signal received from said door switch.

6. The alert indication signaling device of claim 1, further comprising a plurality of pushbuttons that enables navigations and customization of user-configurable features of said alert indication device.

7. The alert indication signaling device of claim 6, wherein each of said pushbuttons comprises a plurality of settings comprising an alarm audio level, a display backlight, a date and time, Wi-Fi settings, Bluetooth™ technology settings, alarm forwarding addresses, and an alarm location identifier assignment.

8. The alert indication signaling device of claim 1, wherein a plurality of audio messages remain off until existing audio messages are terminated, when an alarm silence is activated.

9. A portable alert indication signaling device comprising:
a first detector that detects a first event;
a line detector that detects a second event comprising an incoming call on a communication device;
a doorbell detector that detects a third event comprising a door bell or an entry alarm when said doorbell switch is turned ON or OFF;
a microcontroller directly connected to said first detector, said line detector, and a doorbell detector, wherein said microcontroller transmits at least one signal based on at least one of said first event, said second event, and said third event;
a display unit directly connected to said microcontroller, wherein said display unit displays a visual message that indicates an occurrence of at least one of said first event, said second event, and said third event based on said at least one signal; and
a speaker operatively connected to said display unit, wherein said speaker produces an audio output that corresponds to said visual message and at least one of said first event, said second event, and said third event, and wherein said audio output and said visual message are concurrent.

10. The portable alert indication signaling device of claim 9, further comprising a doorbell switch directly connected to said doorbell detector and said microcontroller.

11. The portable alert indication signaling device of claim 9, further comprising a door switch directly connected to said microcontroller.

12. The portable alert indication signaling device of claim 9, further comprising a plurality of pushbuttons that enables navigation and customization of user-configurable features.

13. The portable alert indication signaling device of claim 12, wherein each of said pushbuttons comprises a plurality of settings comprising an alarm audio level, a display backlight, a date and time, Wi-Fi settings, Bluetooth™ technology settings, alarm forwarding addresses, and an alarm location identifier assignment.

14. A method of providing an alert, said method comprising:
detecting an event that indicates a safety threat;
detecting an incoming call on a communication device;
transmitting a signal from a microcontroller to a display unit and a speaker based on said safety threat or said incoming call;
displaying a visual message that indicates an occurrence of at least one of said safety threat or said incoming call; and
concurrently playing an audio message that corresponds to said visual message and said at least one of said safety threat or said incoming call.

15. The method of claim 14, wherein said safety threat comprises any of carbon monoxide detection, smoke detection, and an emergency condition.

16. The method of claim 14, further comprising detecting by said microcontroller, an opening or closing of a door based on a signal received from a door switch.
